(19) United States
(12) Patent Application Publication
(10) Pub. No.: US 2006/0238051 A1
(43) Pub. Date: Oct. 26, 2006

(54) ELECTRIC ACTUATOR

(75) Inventors: Naoto Sesita, Kawasaki-shi (JP); Katuyuki Tanaka, Kawasaki-shi (JP); Yusuke Mizukoshi, Kawasaki-shi (JP); Hiroyuki Kurihara, Fujisawa-shi (JP); Yoshihisa Watanabe, Yokohama-shi (JP)

Correspondence Address: ZARLEY LAW FIRM P.L.C., CAPITAL SQUARE, 400 LOCUST, SUITE 200, DES MOINES, IA, 50309-2350, US

(73) Assignee: Igarashi Electric Works Ltd., Kawasaki-shi (JP)

(21) Appl. No.: 11/382,503

(22) Filed: May 10, 2006

(30) Foreign Application Priority Data
Apr. 26, 2005 (JP) 2005-128416

(51) Int. Cl. H02K 5/10; H02K 5/00

(52) U.S. Cl. 310/90; 74/425; 310/89; 310/88

(57) ABSTRACT

An electric motor comprises a motor case having a motor shaft and a gear case assembled with the motor case detachably. The motor shaft comprises a base end, an intermediate portion, and a remote end which are supported by the first, the second and the third bearing devices, respectively. The third bearing device has a slide bearing, a cap, an adjusting screw, and a lock nut. The adjusting screw stabilizes an axial clearance of the motor shaft. The slide bearing is engaged in a larger diameter bore of a shaft bore.

### BACKGROUND OF THE INVENTION

The present invention relates to an electric actuator used in a drive train such as a power tail gate or a sliding door of an automobile, and specifically relates to a compact motor-contained electric actuator.

It is desirable to minimize and lighten such an electric actuator in addition to improvement in an output because of constraints for installation space and load weight, etc.

As described in JP2005-030545A (FIG. 1), a known electric actuator has a structure in which a motor case forming a motor body and a gear housing accommodating a worm wheel which forms a reduction mechanism are assembled detachably, a worm meshing with a worm wheel is formed on one side of a motor shaft extending from the motor case in the gear housing. The motor shaft is supported on three points comprising a base end of the motor case, an intermediate portion of an iron core and the worm, and an end portion of the gear housing.

In the bearing structure described above, the motor shaft is inserted in the gear housing from the inside of the motor case, and one end of the motor shaft is merely inserted and supported rotatably in an insert hole formed on the end in the gear housing, making it impossible to keep an axial clearance of the motor shaft stable. Also, a tiny clearance is formed between the motor shaft and a slide bearing because the intermediate portion of the motor shaft is inserted in and supported by the slide bearing. Consequently, when the motor shaft rotates, the end of the motor shaft is likely to become shaky by meshing reaction force between the worm and the worm wheel, and meshing depth of the worm wheel becomes shallow. Only the worm wheel is likely to be broken, but also the motor shaft moves axially and tends to shake, causing vibration and noise.

In case that the insert hole for one end of the motor shaft is formed as a blind hole with a drill from the inside of the gear housing of the motor case, the drill must be inserted into the gear housing deeply, and it is difficult to keep its axis accurate.

### SUMMARY OF THE INVENTION

In view of the disadvantages in the prior art, it is an object of the invention to provide an electric actuator in which an axial clearance of a motor shaft is kept constant, breakage of a worm wheel and vibration and noise caused by shaking of the motor shaft when the motor shaft rotates are prevented, and an axis accuracy by opening a hole in a gear housing can be kept.

### BRIEF DESCRIPTION OF THE DRAWINGS

FIG. 1 is a vertical sectional side view showing an embodiment of an electric actuator according to the present invention;

FIG. 2 is an exploded perspective view of a motor body and a reduction mechanism;

FIG. 3 is a sectional view seen from III-III in FIG. 1; and

FIG. 4 is an enlarged sectional view taken along the line IV-IV of FIG. 3.

### DETAILED DESCRIPTION OF PREFERRED EMBODIMENT

An electric actuator 1 according to the present invention comprises a compact motor body 2 and a reduction mechanism “A”. The motor body 2 as a main part is described below.

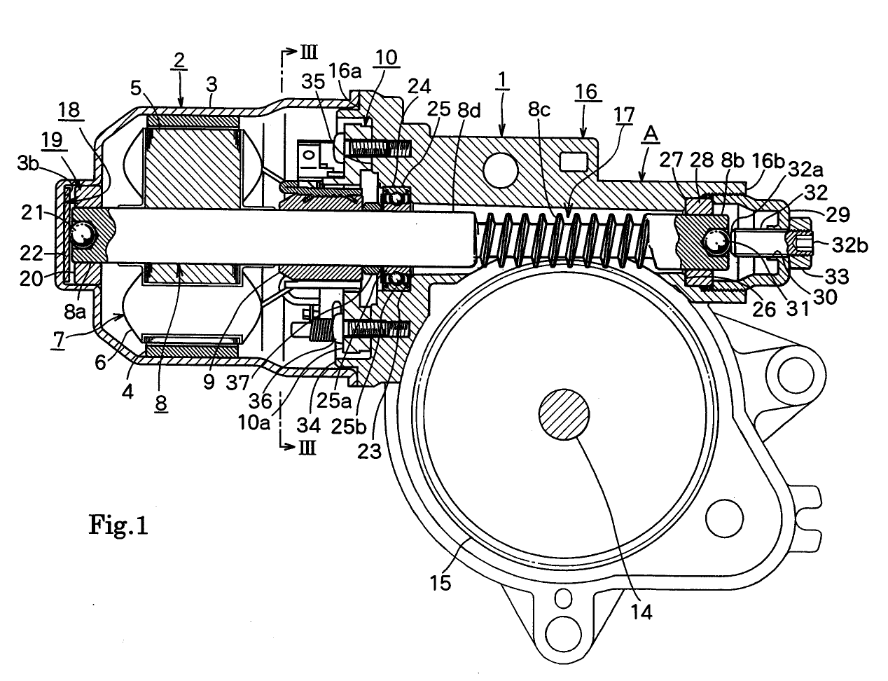

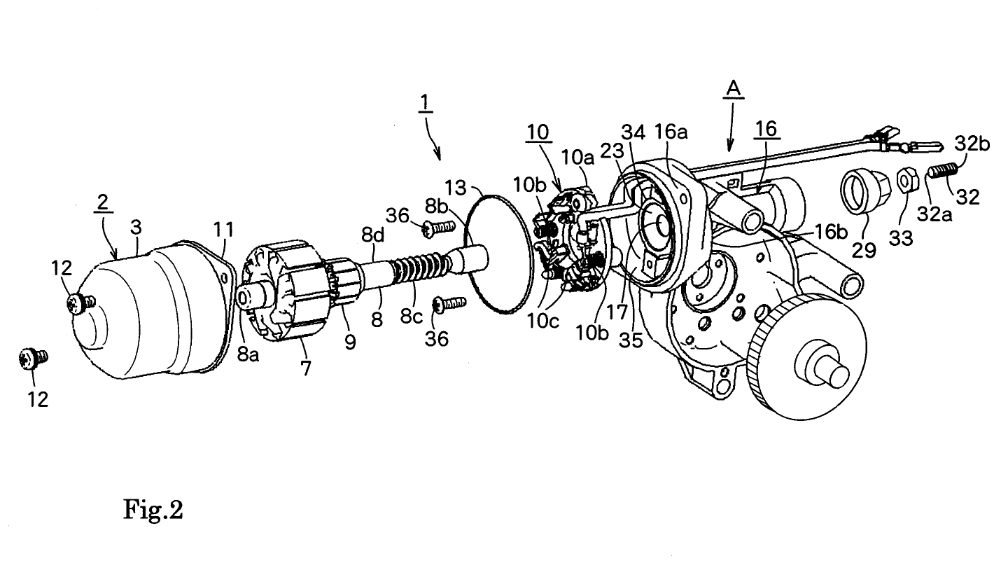

As shown in FIGS. 1 and 2, the motor body 2 comprises a thin-walled cylindrical motor case 3 made of Al alloy having a closed end and processed with deep drawing, a stator 4 comprising a Nd—Fe—B magnet fixed on the inner circumferential surface of the motor case 3, a rotor 7 having cores 5 facing the circumferential surface of the stator 4 on which coils 6 are formed, a motor shaft 8 pressingly fitted in the rotor 7, a commutator 9 pressingly fitted on the shaft 8, and a brush unit 10 for feeding the commutator 9.

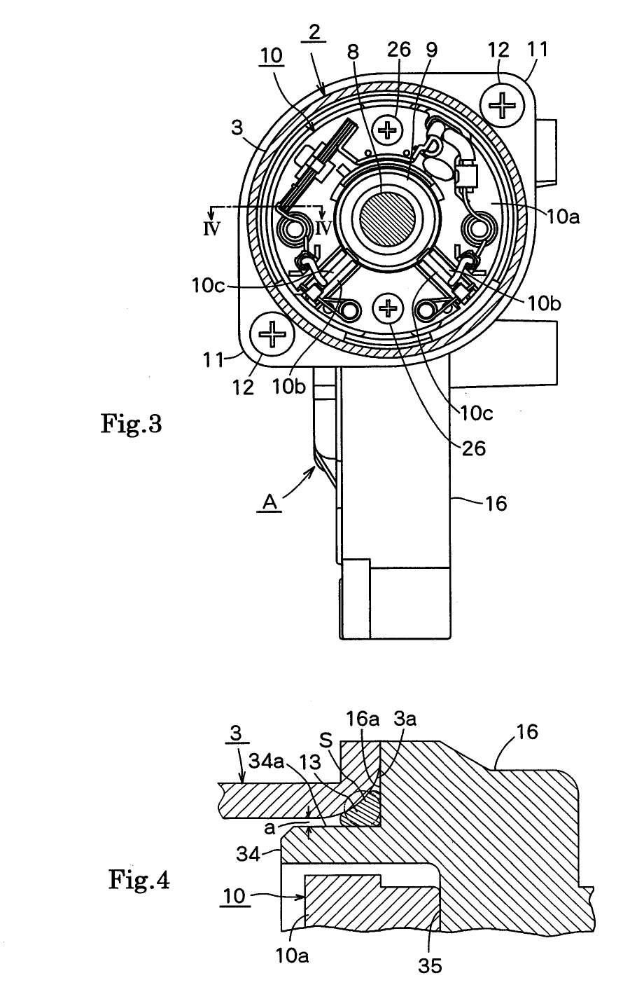

As shown in FIG. 3, the brush unit 10 comprises an insulator 10a and brushes 10c assembled on the insulator 10a by brush holders 10b. The brushes 10c are positioned in sliding contact with the commutator 9 perpendicular to an axis thereof.

The rotor 7 is pressingly fitted at the side of a base end 8a of the motor shaft 8, and the commutator 9 is pressingly fitted on the motor shaft 8 adjacent to the rotor 7 at the open end of the motor case 3.

As shown in FIG. 4, an inner edge portion 3a at the open end of the motor case 3 is rounded and a pair of outward flanges 11, 11 is formed projectingly to face each other on a diagonal line in a radial direction with respect to the axis of the motor shaft 8. The flanges 11, 11 are attached on an inner end face 16a of a cast aluminum gear case 16 of the reduction mechanism “A” accommodating a worm wheel 15 which is supported on a shaft 14 by clamping bolts 12, 12 and an elastic rubber O ring 13, which makes it possible to assemble the motor case 3 and the gear case 16 detachably.

The motor shaft 8 is inserted in a shaft bore 17 in the gear case 16 and extends axially in the gear case 16. A worm 8c meshing with the worm wheel 15 is formed near a remote end 8b of the motor shaft 8 in the gear case 16. The base end 8a of the motor shaft 8 in the motor case 3 has a certain diameter enough to be rigid to bear a weight of the rotor 7.

The base end 8a of the motor shaft 8 is supported by the first bearing device 19 which is accommodated in a recess 18 formed on the closed end of the motor case 3.

The first bearing device 19 comprises a slide bearing 20 in the recess 18, and a stopper 22 which supports the base end 8a of the motor shaft 8 inserted in the slide bearing 20 on the closed end 3b via a ball 21.

An intermediate portion 8d of the motor shaft 8 positioned between the side of the base end 8a on which the core 5 and the commutator 9 are pressingly fitted and the worm 8c is supported by the second bearing device 24. The device 24 is assembled in a larger-diameter bore 23 formed at the shaft bore 17 and opened to the inner end face 16a of the gear case 16 at the side of the motor case 3.

The second bearing device 24 comprises a ball bearing 25 which is engaged in the bore 23 of the shaft bore 17 from the inside of the gear case 16 and the intermediate portion 8d of the motor shaft 8 is pressingly fitted on an inner race 25a.

The remote end 8b of the motor shaft 8 is supported by the third bearing device 27 which is assembled in an outer larger-diameter bore 26 formed at the outer end of the shaft bore 17 and opened to an outer end face 16b of the gear case 16 from outside the gear case 16.

The third bearing device 27 comprises a slide bearing 28 which is engaged in the bore 26; a cap 29 which is screwed in the bore 26 of the shaft bore 17 to fix the slide bearing 28 therebetween; an adjusting screw 32 which penetrates an insert bore 30 axially formed at the center of the cap 29 to support the remote end 8b of the motor shaft 8 via a ball 31 by the inner end 32a; and a lock nut 33 which is screwed outside the gear case 16 on an outer end portion 32b of the adjusting screw 32 which projects from the cap 29. The remote end 8b of the motor shaft 8 is inserted into and supported by the slide bearing 28, and the lock nut 33 is welded on the cap 29 in alignment with the insert bore 30.

Axial clearance of the motor shaft 8 is adjusted by turning the adjusting screw 32 to keep constant thereby restraining axial movement of the motor shaft 8, so that vibration and noise by shaking of the motor shaft 8 are prevented.

Also, the slide bearing 28 supporting the remote end 8b of the motor shaft 8 is engaged in the outer larger-diameter bore 26 of the shaft bore 17 and is fixed by the cap 29 from outside, making it possible to assemble the motor shaft 8 and the slide bearing 28 easily and simply. As it is possible to make the bore 26 in the gear case 16 from outside, a short drill is enough for the process so that axis accuracy can be kept.

Moreover, as the intermediate portion 8d of the motor shaft 8 is supported by the ball bearing 25 which receives a thrust-radial load, the shaking by meshing force between the worm 8c and the worm wheel 15 can be prevented when the motor shaft 8 rotates.

A cylindrical receiving portion 34 projects concentrically around the axis of the shaft bore 17 on the end face 16a of the gear case 16 facing the opening end of the motor case 3. As shown in FIG. 4, the elastic rubber O ring 13 is expanded to engage on the circumferential surface 34a of the receiving portion 34. Then, the inner edge portion 3a of the open end of the motor case 3 is engaged, each of the outward flanges 11, 11 is made to contact the end face 16a of the gear case 16, and the bolts 12, 12 are screwed in the flanges 11, 11 to allow the motor case 3 to be joined to the gear case 16 at two support points.

In other words, as shown with two dotted line in FIG. 4, the O ring 13 has a circular cross section at least slightly larger than an area of a space “S” surrounded by the edge portion 3a at the open end of the motor case 3 and the outer face 34a of the receiving portion 34 of the gear case 16. When the open end of the motor case 3 is pressingly fitted on the outer face 34a of the receiving portion 34, the O ring 13 is squeezed in deformation by pressing the edge portion 3a of the motor case 3. The O ring 13 is partially put into a small gap “a” between the edge portion 3a of the motor case 3 and the outer circumferential surface 34a of the receiving portion 34 of the gear case 16, and the edge portion 3a of the motor case 3 is evenly pressed outwards in a radial direction by restoring force. After forming the gap “a” apart equally in a circumferential direction from the gear case 16, the outward flanges 11, 11 of the motor case 3 are joined pressingly on the end face 16a of the gear case 16, and the bolts 12, 12 are screwed. Therefore, the motor case 3 can be axially aligned with the gear case 16 precisely.

The receiving portion 34 projecting on the inner end face of the gear case 16 has an annular groove 35. The insulator 10a of the brush unit 10 which holds brushes 10c perpendicular to the axis of the commutator 9 is connected on the groove 35 by bolts 36.

As shown in FIG. 1, the ball bearing 25 which supports the intermediate portion 8d of the motor shaft 8 is positioned adjacent to the commutator 9 which is pressingly fitted at the side of the motor case 3, and a collar 37 is interposed on the motor shaft 8 therebetween.

The collar 37 comprises an elastic rubber ring which has an isosceles trapezoid form in cross section widening toward the axis of the motor shaft 8 and one end face of the collar 37 is pressingly contacted on the inner race 25a of the ball bearing 25 to apply axially outward pressure to the inner race 25a.

The pressure of the collar 37 prevents the inner race 25a from moving axially toward the motor case 3 with reference to the outer race 25b of the ball bearing 25 by the meshing reaction force between the worm 8c and the worm wheel 15 when the motor shaft 8 rotates. Vibration and noise by shaking of the inner race 25a are prevented. Lubricant applied to the motor shaft 8 and the ball bearing 25 is prevented from leaking.

Because the collar 37 comprises the elastic rubber ring which has the isosceles trapezoid form in cross section widening toward the axis of the motor shaft 8, an absorption stroke by extension and contraction in the axial direction of the motor shaft 8 becomes greater, so that fluctuations of machining accuracy of the components in terms of the axial size of the commutator 9 which is pressingly fitted on the motor shaft 8 and the size in a depth direction of the motor case 3 is absorbed. Therefore, the increasing cost by improving machining accuracy of the components in the prior art is prevented.

The foregoing merely relate to an embodiment of the invention. Various changes and modifications may be made by a person skilled in the art without departing from the scope of claims wherein:

What is claimed is:

1. An electric actuator comprising:
a motor shaft extending in a shaft bore axially formed in the actuator, said motor shaft having a base end and a remote end;
a cylindrical motor case having a motor body that comprises a rotor pressingly fitted on the motor shaft near the base end and a stator fixed to the motor case, said stator facing the rotor;
a gear case having a worm between the base end and the remote end and a worm wheel meshing with the worm, said gear case being detachably mounted to the motor case;
a first bearing device at the base end of the motor shaft to support the motor shaft;
a second bearing device between the base end and the remote end to support the motor shaft; and
a third bearing device at the remote end, said third bearing device comprising a slide bearing engaged in a larger-diameter bore of the shaft bore around the remote end of the motor shaft; an outer cap engaged in the larger-diameter bore to fix the slide bearing; an adjusting screw extending axially to support the motor shaft at the remote end; and a lock nut engaged on the adjusting screw outside the gear case to hold the adjusting screw.

2. An electric actuator as claimed in claim 1 wherein the first bearing device comprises a slide bearing in which the base end of the motor shaft is put, said slide bearing being held in a recess of the motor case; and a stopper supporting the base end of the motor shaft.

3. An electric actuator as claimed in claim 1 wherein the second bearing device comprises a ball bearing in a larger diameter bore of the shaft bore at an opening end of the gear case, the motor shaft being pressingly supported in an inner race of the ball bearing.
